(19) United States
(12) Patent Application Publication
(10) Pub. No.: US 2019/0384698 A1
(43) Pub. Date: Dec. 19, 2019

(54) TEST SYSTEM

(71) Applicant: Acer Incorporated, New Taipei City (TW)

(72) Inventors: Ying-Shih Hung, New Taipei City (TW); Cheng-Tse Wu, New Taipei City (TW); An-Cheng Lee, New Taipei City (TW); Yun-Hao Chou, New Taipei City (TW); Chao-Kuang Yang, New Taipei City (TW)

(73) Assignee: Acer Incorporated, New Taipei City (TW)

(21) Appl. No.: 16/112,796

(22) Filed: Aug. 27, 2018

(30) Foreign Application Priority Data
Jun. 14, 2018 (TW) 107120513

(51) Int. Cl. G06F 11/36; G06K 9/62

(52) U.S. Cl. CPC G06F 11/3684; G06F 11/3692; G06F 11/3688; G06K 9/6202

(57) ABSTRACT

A test system including an image capturing apparatus, a server apparatus, and a behavior actuation apparatus is provided. The server apparatus is coupled to the image capturing apparatus, drives the image capturing apparatus to take an image of an application of a device under test, analyzes the image to obtain object information in the image, and obtains a corresponding test procedure based on the object information. The behavior actuation apparatus is coupled to the server apparatus, receives the test procedure from the server apparatus, generates a control signal based on the test procedure, and transmits the control signal to the device under test as an inputting signal of the application.

### CROSS-REFERENCE TO RELATED APPLICATION

This application claims the priority benefit of Taiwan application serial no. 107120513, filed on Jun. 14, 2018. The entirety of the above-mentioned patent application is hereby incorporated by reference herein and made a part of this specification.

### BACKGROUND

### Technical Field

The invention relates to a test technology. More particularly, the invention relates to an automated test system.

### Description of Related Art

In the development of information communication products, a large number of repeated test procedures are required to ensure the quality of the products. Nevertheless, uncertainty is often observed in a test process, and barrier to entry and costs of test automation are high, as such, most of the test requirements are completed manually. Along with the advancement of artificial intelligence and Internet of Things, test automation technologies are developed. The current test automation technologies mainly include Windows UI Automation, Android UiAutomator, and Sikuli. Nevertheless, numerous defects can still be found in these test automation technologies, which lead to inconvenience for testers.

Since the existing test automation technologies depend on the system platform of the device under test (DUT), a tester has to be familiar with various types of operating environments and write different test programs according to different operating environments. For instance, Windows UI Automation is required to be operated in a Windows operating system environment. Android UiAutomator supports only the Andorid operating system. Sikuli has to rely on a Java virtual machine.

Moreover, the existing test programs have low fault tolerance. That is, for test technologies which adopt graphic matching to work such as Sikuli, when a different DUT screen, a different operating system, a different display language, or a different browser is provided, incorrect graphic matching is likely to occur owing to a different screen size, a screen resolution configuration, an application or a web page layout. During operation, if the screen is switched or an unexpected window appears, execution error may also occur. In the automation test examples based on Windows UI Automation or Android UI Automator, the object display text is used to identify the attributes of the object, which also causes the test programs to become incompatible in the display languages of different operating systems.

The existing test automation technologies are unable to support tests provided before the operating environment is loaded. Windows UI Automation, Android UI Automator, and Sikuli all require the support of the operating system of the device under test to work. Hence, test items, such as basic input/output system (BIOS), image preload, and out-of-box experience (OOBE), which are loaded prior to the operating system, are unable to adopt the existing test automation technologies.

A barrier to entry of test automation is high because a tester needs to know programming languages and thus may need a longer pre-learning period. For instance, standard programming languages (e.g., C++ and Java) are required when using Windows UI Automation and Android UI Automator to develop the test programs, and Sikuli uses a graphical programming language developed by its own. Since these programming languages are difficult to understand, when a problem occurs, a field tester may not immediately solve the problem most of the time.

Before executing an automation test by using the existing test automation technologies, test programs or related test platforms are required to be additionally installed in the device under test. When the automation test is executed, the test programs may run in the background and occupy system resources. As such, when a system performance test is executed, a test result may be affected owning to the test programs.

In light of the above, when a large number of tests are required to be executed, if the existing test automation technologies are to be adopted, different test programs are required to be written according to the operating environment of the device under test, compatibility of the test programs is required to be adjusted under different operating systems, tests provided before the operating systems are loaded are required to be additionally executed, and pre-learning is required for the tester. The tester has to spend tremendous amount of time and efforts to confirm and adjust each device under test; thereby, deployment of a large number of automation tests becomes more difficult.

### SUMMARY

The invention provides a test system which provides a test automation system and a method which do not rely on an operating system of a device under test and do not require use of a programming language.

A test system provided by an embodiment of the invention is configured to test a device under test. The test system includes an image capturing apparatus, a server apparatus, and a behavior actuation apparatus. The server apparatus is coupled to the image capturing apparatus, drives the image capturing apparatus to take an image of an application of the device under test, analyzes the image to obtain an object information in the image, and obtains a corresponding test procedure based on the object information. The behavior actuation apparatus is coupled to the server apparatus, receives the test procedure from the server apparatus, generates a control signal based on the test procedure, and transmits the control signal to the device under test as an inputting signal of the application.

In an embodiment of the invention, the server apparatus includes an object model, an object detection module, and a test script interpretation module. The object model stores a plurality of feature parameters corresponding to a plurality of interface objects. The object detection module analyzes the image based on the feature parameters to obtain the object information corresponding to at least one of the interface objects in the image. The test script interpretation module interprets the object information based on a test script to obtain the corresponding test procedure and transmits the test procedure to the behavior actuation apparatus.

In an embodiment of the invention, the server apparatus further includes an abnormality notification module coupled to the test script interpretation module and configured to send an abnormality notification signal.

In an embodiment of the invention, the application generates a plurality of testing images, and the server apparatus obtains the testing images taken by the image capturing apparatus to obtain a plurality of training images. Each of the training images is analyzed based on the feature parameters through the object detection module to obtain the interface objects in the training images. The server apparatus further includes an object attribute editing module configured to modify the object attributes of the interface objects and a script writing module configured to generate a test script based on the object attributes of the interface objects.

In an embodiment of the invention, the object attributes include an object category, position information, an execution sequence, an execution behavior, and wait time.

In an embodiment of the invention, the behavior actuation apparatus includes a first signal transmission interface, a second signal transmission interface, and a microcontroller. The first signal transmission interface is coupled to the server apparatus to receive the test procedure. The second signal transmission interface is coupled to the device under test. The microcontroller is coupled to the first signal transmission interface and the second signal transmission interface and executes an input device simulator. The input device simulator generates the control signal simulating an input behavior of the device under test based on the test procedure received from the first signal transmission interface and transmits the control signal to the device under test.

In an embodiment of the invention, the input device simulator is comprises at least one of a keyboard simulator, a mouse simulator, a touch screen simulator, a robot arm simulator, a speaker simulator, and a relay simulator.

To sum up, in the embodiments of the invention, the image capturing apparatus is used to take the image of the application of the device under test, and the object in the image is identified through analysis conducted by artificial intelligence. Further, the corresponding test procedure is obtained according to the test script to drive the behavior actuation apparatus to simulate the input behavior of the device under test, and automation of the test process is thereby achieved.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is an architecture diagram of a test system according to an embodiment of the invention.

FIG. 2 is an architecture diagram of a test execution system according to an embodiment of the invention.

FIG. 3 is a flow chart of a test method according to an embodiment of the invention.

FIG. 4 is an architecture diagram of a test script writing system according to an embodiment of the invention.

### DESCRIPTION OF THE EMBODIMENTS

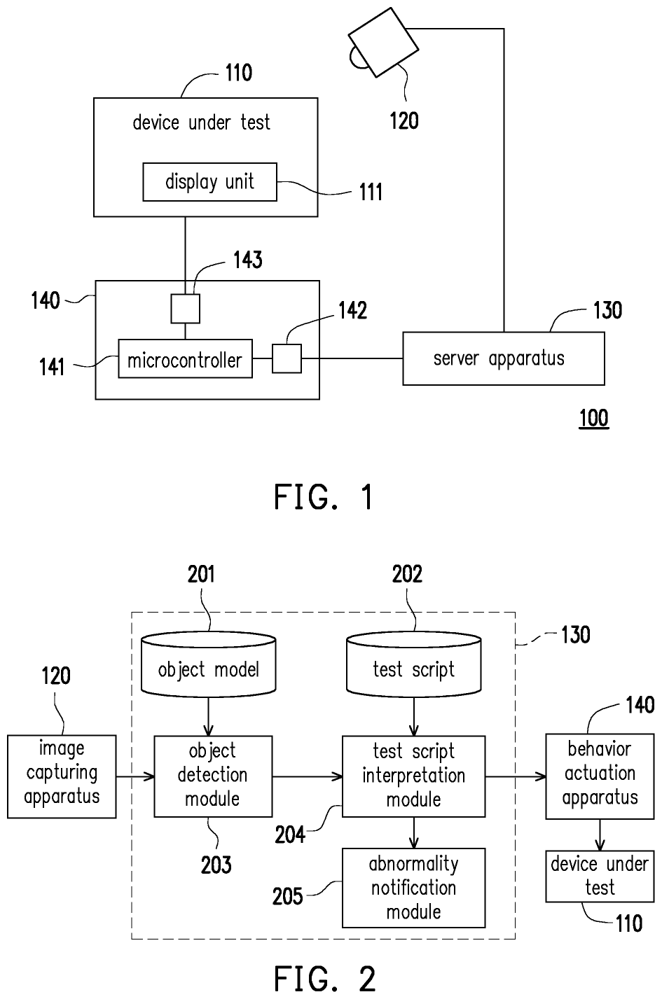

FIG. 1 is an architecture diagram of a test system according to an embodiment of the invention. With reference to FIG. 1, a test system 100 includes a device under test 110, an image capturing apparatus 120, a server apparatus 130, and a behavior actuation apparatus 140. The server apparatus 130 is coupled to the image capturing apparatus 120 and the behavior actuation apparatus 140. The behavior actuation apparatus 140 is coupled to the device under test 110.

The device under test 110 includes a display unit 111. The display unit 111 is configured to display a frame of an application. The device under test 110 may be implemented to act as a mobile phone, a tablet computer, a notebook computer, a desktop computer, and other electronic apparatuses providing a computing function.

The image capturing apparatus 120 may be a digital camera or an analog camera capable of outputting digital images and may adopt a charge coupled device (CCD) lens or a complementary metal oxide semiconductor transistors (CMOS) lens and the like.

The server apparatus 130 is an electronic apparatus providing an enhanced computing function such as a notebook computer, a desktop computer, etc. The server apparatus 130 includes a processor and a storage device. A plurality of modules are stored in the storage device, and the processor drives the modules to implement each step of a test method.

The processor may be implemented to act as a central processing unit (CPU), a graphic processing unit (GPU), a physics processing unit (PPU), a programmable microprocessor, an embedded control chip, a digital signal processor (DSP), an application specific integrated circuits (ASIC), or other similar devices. The storage device is a fixed or movable random access memory (RAM), a read-only memory (ROM), a flash memory, a secure digital memory card (SD), a hard disk, or other similar devices of any types or a combination of the foregoing devices.

The image capturing apparatus 120 may be integrated on the server apparatus 130, or the image capturing apparatus 120 and the server apparatus 130 may be two separate apparatuses, which is not limited herein.

The behavior actuation apparatus 140 is configured to simulate an input behavior of the device under test 110. For instance, the behavior actuation apparatus 140 provides functions of a keyboard simulator and a mouse simulator if the device under test 110 is a personal computer, and the behavior actuation apparatus 140 provides a function of a touch screen simulator if the device under test 110 is a smartphone with a touch screen. The behavior actuation apparatus 140 is composed of a single chip microcontroller development board, and the behavior actuation apparatus 140 may be implemented through Arduino YUN.

Further, the behavior actuation apparatus 140 includes a microcontroller 141, a first signal transmission interface 142, and a second signal transmission interface 143. The microcontroller 141 is coupled to the first signal transmission interface 142 and the second signal transmission interface 143. The first signal transmission interface 142 is coupled to the server apparatus 130 to receive a test procedure. The second signal transmission interface 143 is coupled to the device under test 110. The first signal transmission interface 142 may be a wireless network interface or an Ethernet interface and the like. The second signal transmission interface 143 may be a universal serial bus (USB). The microcontroller 141 is configured to execute an input device simulator. The input device simulator comprises at least one of a keyboard simulator, a mouse simulator, a touch screen simulator, a robot arm simulator, a speaker simulator, and a relay simulator. The input device simulator generates a control signal simulating an input behavior of the device under test 110 based on the test procedure received from the first signal transmission interface 142 and transmits the control signal to the device under test 110 as an inputting signal of the application. The keyboard simulator is configured to simulate the input behavior of a keyboard. The mouse simulator is configured to simulate the input behavior of a mouse. The touch screen simulator is configured to simulate the input behavior of a touch screen. The robot arm simulator is configured to simulate behavior of moving and shaking the device under test 110 and simulates behavior of adjusting a flipping angle when the device under test 110 is a flip device. The speaker simulator is configured to simulate voice input. The relay simulator is configured to simulate swapping of a charger and an input/output device.

The server apparatus 130 transmits the test procedure to the behavior actuation apparatus 140. The behavior actuation apparatus 140 transmits the test procedure to the microcontroller 141 via a network control module (not shown) by the first signal transmission interface 142 such as the wireless network interface or the Ethernet interface and the like. Accordingly, the microcontroller 141 may execute the test procedure transmitted from the server apparatus 130. Next, the microcontroller 141 is further connected to the second signal transmission interface 143 through the network control module which is not shown and inputs the control signal to the device under test 110.

FIG. 2 is an architecture diagram of a test execution system according to an embodiment of the invention. With reference to FIG. 2, the server apparatus 130 includes an object model 201, a test script 202, an object detection module 203, a test script interpretation module 204, and an abnormality notification module 205. The object detection module 203, the test script interpretation module 204, and the abnormality notification module 205 may be software modules stored in the storage device of the server apparatus 130, are composed of one or a plurality of code snippets, and are executed through the processor to perform corresponding functions. In addition, the object detection module 203, the test script interpretation module 204, and the abnormality notification module 205 may also be hardware composed of a microcontroller chip, which is not limited herein. The test execution system is responsible for executing the test script 202.

The image capturing apparatus 120 is mainly configured to capture the frame displayed by the display unit 111 of the device under test 110 and submits the captured image to the object detection module 203 for analyzing. The object detection module 203 analyzes the image obtained from the image capturing apparatus 120 based on a feature parameter in the object model 201, so as to obtain object information corresponding to one or a plurality of interface objects in the image. The object model 201 stores a plurality of feature parameters corresponding to the interface objects. The object model 201 and the object detection module 203 are matched with each other.

In this embodiment, the object model 201 stores the feature parameters of various types of the interface objects. The interface objects include a plurality of object categories, for example, a Button, a CheckBox, a ComboBox, a DateTimePicker, a Label, a LinkLabel, a ListBox, a ListView, a RadioButton, and a TextBox object category and the like.

The object detection module 203 is an artificial intelligence processing device and is capable of analyzing an input image and obtaining one or a plurality of defined interface objects. The object detection module 203 may adopt a deep learning neural network. The object detection module 203 performs convolution and pooling actions to the image obtained from the image capturing apparatus 120, so as to extract feature information in the image and rationalize data volume. The convolution and pooling actions may be repeated for several times so as to optimize a feature, and then a result is inputted to a trained deep artificial neural network to obtain identified object information.

The test script interpretation module 204 is configured to interpret the object information obtained from the object detection module 203 based on the test script 202, so as to obtain the corresponding test procedure and transmit the test procedure to the behavior actuation apparatus 141. The test script 202 is generated by a test script writing system to be described later and is configured to instruct the behavior actuation apparatus 140 when to perform what type of operation.

When abnormality occurs in a test process, a notification can be issued through the abnormality notification module 205, so as to notify the tester in charge and provide assistance in resolving a situation. The abnormality notification module 205 is coupled to the test script interpretation module 204 and is configured to send an abnormality notification signal. Abnormal events defined herein may mainly be divided into three categories, namely object detection abnormality, object interpretation abnormality, and behavior actuation abnormality.

The object detection abnormality is issued from the object detection module 203, and the abnormality notification module 205 is notified through the test script interpretation module 204. Abnormality of this kind occurs when an object on the frame of the device under test 110 can not be correctly identified through the object detection module 203, and the tester in charge has to manually provide the object information to eliminate the abnormality.

The object interpretation abnormality is issued from the test script interpretation module 204 most of the time. That is, when the test script interpretation module 204 finds out that an object type and an object quantity detected by the object detection module 203 are not matched with that defined by the test script 202, the test script interpretation module 204 issues the object interpretation abnormality to the abnormality notification module 205. When such problem occurs, the tester in charge has to manually correct the object information or content of the test script to eliminate the abnormality.

The behavior actuation abnormality is issued from the behavior actuation apparatus 140, and the abnormality notification module 205 is notified through the test script interpretation module 204. The behavior actuation abnormality occurs when the behavior actuation apparatus 140 can not perform an execution behavior given by the test script 202. When such problem occurs, the tester in charge has to reset or replace the behavior actuation apparatus 140.

The abnormality notification module 205 may include an abnormality receiving unit, an abnormality notification issuing unit, an abnormality processing prompt unit, and an abnormality processing execution unit. The abnormality receiving unit is responsible for receiving an abnormal event (object detection abnormality, object interpretation abnormality, or behavior actuation abnormality) issued from the object detection module 203, the test script interpretation module 204, and the behavior actuation apparatus 140. The abnormality notification issuing unit is responsible for issuing a notification through a pre-determined notification method. For instance, the abnormality notification issuing unit may issue a notification through instant messaging software, an e-mail, or a text message and the like. The abnormality processing prompt unit issues a prompt in the server apparatus 130 according to the abnormal event and waits for instructions from the tester in charge or performs actions to eliminate abnormality.

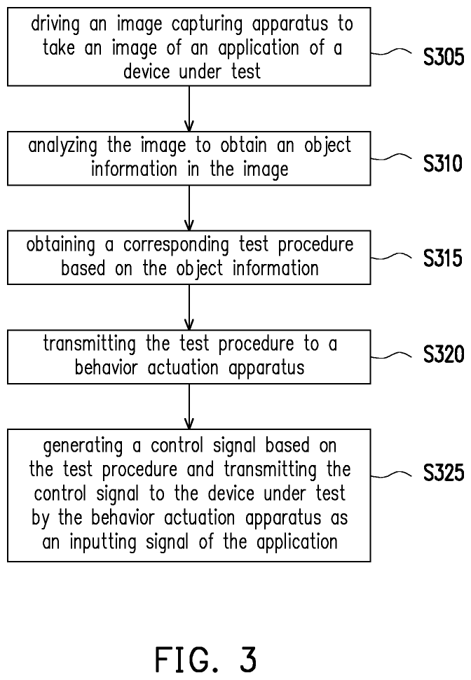

FIG. 3 is a flow chart of a test method according to an embodiment of the invention. With reference to FIG. 1 to FIG. 3 together, in step S305, the server apparatus 130 drives the image capturing apparatus 120 to take an image of an application of the device under test 110.

Next, in step S310, the server apparatus 130 analyzes the image to obtain an object information in the image. Afterwards, in step S315, the server apparatus 130 obtains a corresponding test procedure based on the object information, and in step S320, transmits the test procedure to the behavior actuation apparatus 140. To be specific, after capturing the image, the image capturing apparatus 120 transmits the image to the object detection module 203, and then the object detection module 203 employs the object model 201 to find object categories and position information of defined interface objects in the image. The position information is coordinate positions of the interface objects in the image, for example, central point positions of the interface objects may be used to represent the coordinate positions. The execution behavior further includes the input device simulator being used and the corresponding actions. Afterwards, the test script interpretation module 204 compares the object categories and the position information with the test script 202 to obtain the corresponding test procedure, that is, an execution sequence, an execution behavior, and wait time corresponding to each of the interface objects.

In step S325, the behavior actuation apparatus 140 then generates a control signal based on the test procedure. For instance, the microcontroller 141 of the behavior actuation apparatus 140 determines which execution behavior of one interface object is to be executed first according to the test procedure. The input device simulator to be used and a corresponding behavior action may be obtained through the execution behavior. The behavior action includes one of a double-clicking action, a left-clicking action, etc.

Actually, in step S325, the behavior actuation apparatus 140 generates the control signal based on the test procedure and transmits the control signal to the device under test 110 as an inputting signal of the application.

For instance, it is assumed that the object category corresponding to an interface object A is identified as the Button object category and the position information of the interface object A is identified as (15, 20) through the object detection module 203. Afterwards, the test script interpretation module 204 compares the object information obtained with the test script 202 to obtain the execution sequence, execution behavior, and wait time corresponding to the interface object A. For instance, the execution sequence of the interface object A is the first, the interface object A uses a mouse simulator, the corresponding behavior action is “double-clicking”, and the wait time is 500 milliseconds. Accordingly, the execution sequence, the execution behavior, and the wait time act as the test procedure and are transmitted to the behavior actuation apparatus 140. In this case, the behavior actuation apparatus 140 generates a control signal of simulating the action of double-clicking of a mouse and transmits the control signal to the device under test 110 after waiting for 500 milliseconds. The device under test 110 performs the corresponding operation in the application based on the control signal received.

Before the test method is executed, the server apparatus 130 has to create the test script first. The application generates a plurality of testing images, and the server apparatus 130 obtains the testing images taken by the image capturing apparatus 120 to obtain a plurality of training images. Artificial intelligence is employed to identify an object being tested in the training images, and the tester in charge can complete writing of the test script only through specifying the object being tested and an execution action in tabular text. Several examples are provided to describe implementation of the test script writing system as follows. The test script writing system provides an environment for the tester in charge to write the test script.

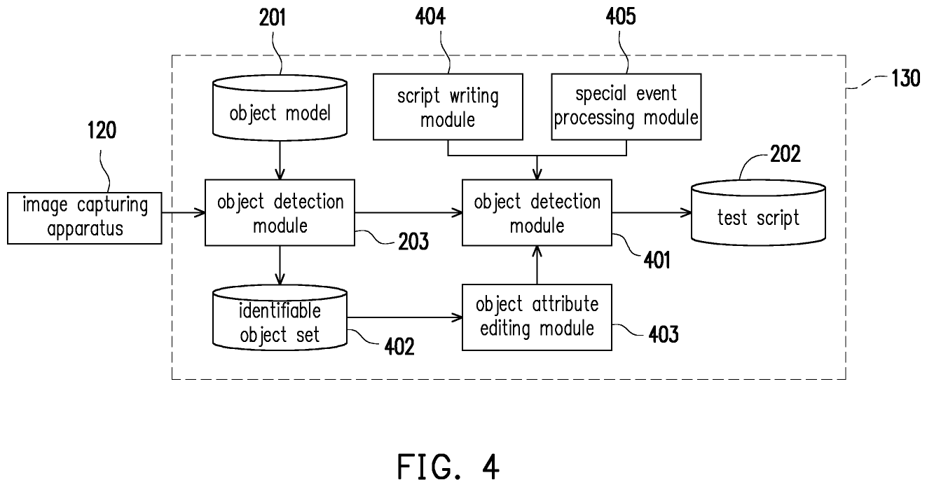

FIG. 4 is an architecture diagram of a test script writing system according to an embodiment of the invention. In this embodiment, the server apparatus 130 further includes a script writing module 401, an identifiable object set 402, an object attribute editing module 403, a special object processing module 404, and a special event processing module 405. The script writing module 401, the object attribute editing module 403, the special object processing module 404, and the special event processing module 405 may be software modules stored in the storage device of the server apparatus 130 and may also be hardware composed of a microcontroller chip, which is not limited herein.

The object detection module 203 stores object information of identifiable interface objects to the identifiable object set 402 and edits object attributes of the identifiable interface objects through the object attribute editing module 403. Moreover, the object detection module 203 notifies the script writing module 401 of the detected interface objects. After obtaining the object attributes of the identifiable interface objects from the object attribute editing module 403, the script writing module 401 further employs the special object processing module 404 and the special event processing module 405 to additionally define the unidentified interface objects.

The identifiable object set 402 is a collection of identifiable interface objects in the training images filtered through the object detection module 203. Each of the interface objects has several object attributes. The object attributes include the object category, position information, the execution sequence, the execution behavior, and the wait time. The execution behavior further includes an actuator and a behavior action. The actuator is a module configured to execute the behavior action. For instance, the actuator may be the input device simulator provided by the behavior actuation apparatus 140. In addition, an attribute of region may be further included so as to conveniently distinguish the execution sequence.

TABLE 1

| | Position | | Execu- | | | |
|---|---|---|---|---|---|---|
| Object | Infor- | | tion Se- | | Behavior | Wait |
| Category | mation | Region | quence | Actuator | Action | Time |
| Button | 15, 20 | 1 | 1 | mouse | double | 500 ms |
| | | | | simulator | clicking | |
| Button | 15, 50 | 1 | 2 | mouse | left | 500 ms |
| | | | | simulator | clicking | |
| TextBox | 15, 90 | 3 | 1 | keyboard | keying in | 1000 ms |
| | | | | simulator | “ABC” | |

For instance, Table 1 is an example of content recorded in the identifiable object set 402. The first attribute is the object category and is configured to identify which control items do the interface objects belong to, including the Button, the CheckBox, the ComboBox, the DateTimePicker, the Label, the LinkLabel, the ListBox, the ListView, the RadioButton, the TextBox, etc. The second attribute is the position information and is configured to present the coordinate positions of the interface objects in the training images. For instance, the central positions of the interface objects are employed to act as the position information, so as to reduce errors occurred in the test process.

The third and the fourth attributes are the region and the execution sequence. Several interface objects sharing the same object category, such as three Buttons, may be presented in the same frame at the same time. In this case, for ease of distinction, the training image captured by the display unit 111 is divided into a plurality of regions and is defined by a fixed rule, such as left to right and then top to bottom. In the same region, the interface objects belonging to the same category are further distinguished according to the execution sequence. The execution sequence may also be defined through a fixed rule, such as left to right and then top to bottom. Sorting is then performed according to the positions of the interface objects to generate the execution sequence. The attribute of region provides one more function. When the image capturing apparatus 120 adopts a plurality of cameras or a camera architecture providing a focusing function, the server apparatus 130 may adopt an output image of a corresponding camera or specify a focusing region of a camera through reading the attribute of region, so as to increase a recognition rate of the object detection module 203. The attributes of region and execution sequence in the identifiable object set 402 are predetermined values only and can be modified through the object attribute editing module 403.

The fifth attribute is the actuator executing the behavior action. For instance, if the “mouse simulator” is marked, the mouse simulator of the behavior actuation apparatus 140 is adopted. The sixth attribute is the behavior action. The behavior action is the action expected to be executed in a test execution phase. The seventh attribute is the wait time, which is the time the test execution system waits with no action after the action is executed. The wait time may be set to reduce errors caused by timing.

The object attribute editing module 403 is configured to modify the object attributes of the interface objects. For instance, the actuator, the behavior action, and the wait time may be set by test script editor through the object attribute editing module 403.

If an interface object which can not be identified by the object detection module 203 exists in the test flow, the interface object may be additionally defined through the special object processing module 404. A special object has five attributes. The first attribute is numbering and is configured to identify each special object. Hence, such attribute is unique because any two objects are not allowed to share a same value. The other four attributes are the position information, the actuator, the behavior action, and the wait time, and definitions thereof are respectively identical to that defined in Table 1. Nevertheless, the four attributes are required to be manually given by the test script editor in the special object processing module 404.

In addition, if an action (e.g., pressing the Windows button) not related to the control items exists in the test flow, the action may be additionally defined through the special event processing module 405. A special event has a total of four attributes. The first attribute is numbering and is configured to identify each special event. Hence, such attribute is unique because any two events are not allowed to share a same value. The other three attributes are the actuator, the behavior action, and the wait time, and definitions thereof are respectively identical to that defined in Table 1. Nevertheless, the three attributes are required to be manually given by the test script editor in the special event processing module 405. In a general test process, screenshots are required most of the time to act as a debugging log or a test process log. In this case, the special event can be defined by defining the actuator as the “image capturing apparatus” and the action as “capturing a screenshot”. The system automatically controls the image capturing apparatus 120 to complete image taking and following processing, such as storing images in a specific folder, automatic numbering, and giving information such as project and time information.

The script writing module 401 is configured to generate the test script 202 based on the object attributes of the interface objects. Herein, the script writing module 401 is a modularized tool, so that the test script 202 may be conveniently developed by the test script editor. A unit of the test script 202 is a page. A typical test script 202 is composed of a plurality of pages so as to complete operation of multiple testing images in the test flow. One page corresponds to one testing image of the device under test 110. Table 2 presents a schematic view of one page in the test script 202.

TABLE 2
Page Number 1

| | Object | Position | Execu- | | | |
|---|---|---|---|---|---|---|
| Action | Category/ | Infor- | tion Se- | | Behavior | Wait |
| Unit | Number | mation | quence | Actuator | Action | Time |
| Identi- | Button | 15, 20 | 1 | mouse | double | 500 ms |
| fiable | | | | simulator | clicking | |
| Interface | | | | | | |
| Object | | | | | | |
| Special | 1 | 15, 50 | N/A | mouse | double | 500 ms |
| Object | | | | simulator | clicking | |
| Special | 1 | N/A | N/A | image | screenshot | 500 ms |
| Event | | | | capturing | | |
| | | | | apparatus | | |

| | |
|---|---|
| Timeout | 10000 ms |

One page is basically composed of three parts, namely the page number, action unit, and timeout. The page number is configured to identify each page. Hence, the page number is unique because any two pages are not allowed to share a same number. The action unit defines the test operation required to be executed in this page and is composed of multiple interface objects (including the identifiable object, the special object, and the special event). The timeout is configured to increase robustness of test execution. If operation of this page is not completed within timeout, or the current testing image of the device under test 110 does not enter the next testing image within timeout, abnormality may be issued further through the abnormality notification module 205.

In addition, the server apparatus 130 may also provide a test environment calibrating system configured to ensure that the image capturing apparatus 120 may obtain an image of an appropriate size for being used by the test execution system and the test script writing system. In this embodiment, in order to provide a favorable practice effect, another object model corresponding to an external frame of the display unit 111 of the device under test 110 is further provided in addition to the object model 201 (the model corresponding to a Windows object). In the test environment calibrating system, the object model corresponding to the external frame of the display unit 111 of the device under test 110 is used to provide boundary box information and mouse position information.

The test environment calibrating system is configured to evaluate whether a boundary box of the display unit 111 of the device under test 110 falls within a tolerance range. The boundary box information is obtained through the another object model, and two sets of values of top and bottom boundaries and left and right boundaries are analyzed. Next, at least one set of the two sets of values of the top and bottom boundaries and the left and right boundaries are ensured to fall within a boundary tolerance range. That is, the top and bottom boundary values fall within a top and bottom boundary tolerance range, or the left and right boundary values fall within a left and right boundary tolerance range. If no set of values falls within the boundary tolerance range, an alert may be issued to further prompt a tester to move the device under test 110 or the image capturing apparatus 120 until at least one set of values falls within the boundary tolerance range. If the two sets of values of the top and bottom boundaries and the left and right boundaries both fall within the boundary tolerance range, the device under test 110 is ensured to be positioned at an appropriate position, and calibrating of the test environment may thus be completed. If only one set of values fall within the boundary tolerance range, calibrating is required to be performed continuously.

In addition, in the test execution system, when the behavior action is performed through the mouse simulator and the touch screen simulator, coordinate values based on screen resolution are required most of the time. Hence, in the phase of calibrating the test environment, screen resolution information is required to be obtained. Herein, the mouse simulator may be used to move a mouse may step by step, and then the artificial intelligence may be used to determine a position of the mouse. The screen resolution is thereby automatically calculated, and manual operation is thus unnecessary. First, mouse coordinates are reset to zero and are reset back an original point of screen resolution coordinates (usually an upper left corner of a screen). Next, the mouse simulator is instructed to move forwards in a given screen direction according to a mouse unit stepping length. The mouse unit stepping length is a fixed amount, for example, 3 pixels, of each advancement of the mouse. The screen direction may be given to move rightwards or downwards in sequence. Next, the mouse coordinates reported by the object detection module 203 are interpreted. If null values are reported by the object detection module 203 for several times, the mouse is determined to move beyond the screen boundary, and stepping count of a last non-null value is reported. The mouse unit stepping length is multiplied by the stepping count of the last non-null value, and the screen resolution in the given screen direction is thus calculated. The calculated screen resolution may be stored as a set of profiles, so that a device under test of a same type can conveniently apply the same set of profiles directly, and that the flow of obtaining the screen resolution is not required to be performed again.

Further, the server apparatus 130 also provides a test environment reading system configured to automatically read a system environment of a test machine. The tester has to record a system environment of the device under test 110 most of the time for use in analyzing a test result. Herein, the server apparatus 130 introduces technologies such as object detection and character recognition, such that automation of such requirement is achieved, and burden of the tester to manually copy the system environment is effectively lowered. The character recognition technology may analyze and identify an image having text information according to a character model, so as to obtain the text information in the image.

For instance, an input frame is pre-processed to filter out non-text parts and eliminate noise (commonly used algorithms include the grayscale post binarization algorithm, the median filtering algorithm, etc.). Next, the text is segmented to obtain a single-character image (the commonly used algorithms include the horizontal projection algorithm, the vertical projection algorithm, etc.). Each character is extracted according to features, and feature values such as an architecture, appearance, and a pixel direction of the character are obtained. Finally, each character is identified by an identifier (the commonly used algorithms include a linear classifier algorithm, a neural network algorithm, a support vector machine algorithm, etc.).

Since the character recognition technology can not provide a 100% identification rate yet, the test environment reading system further presents an original image captured by the image capturing apparatus 120 together with top N possible answers identified by the character recognition technology for the tester to select a correct answer. If the correct answer can not be found among the N possible answers, the test environment reading system also provides an interface for the tester to make manual confirmation and collects samples of poor identification of this type for use in re-training or adjusting the identifier.

In view of the foregoing, in the embodiments of the invention, the test script is not executed in the device under test and is executed by the server apparatus instead. The image capturing apparatus is used to take the image of the application, and the object in the frame is further obtained through analyzing the obtained image by the server apparatus. The behavior actuation apparatus is driven to simulate the input behavior of the device under test, so that the device under test further executes the corresponding operation. Accordingly, the test system does not have to rely on the operating system of the device under test, features a high fault tolerance, supports automation provided before the operating environment is loaded, and requires no additional test procedure to be installed.

Besides, the object-oriented writing method provided by the embodiments allows a general tester to write the test script easily. That is, artificial intelligence is used to identify the object being tested by leveraging the development of artificial intelligence. The tester only has to specify the object being tested and the execution action in tabular text, writing of the test script is then automatically completed. Therefore, the barrier to entry of test automation is significantly lowered for general testers.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A test system, configured to test a device under test, comprising:
an image capturing apparatus;
a server apparatus, coupled to the image capturing apparatus, driving the image capturing apparatus to take an image of an application of the device under test, analyzing the image to obtain an object information in the image, and obtaining a corresponding test procedure based on the object information; and
a behavior actuation apparatus, coupled to the server apparatus, receiving the test procedure from the server apparatus, generating a control signal based on the test procedure, and transmitting the control signal to the device under test as an inputting signal of the application.

2. The test system as claimed in claim 1, wherein the server apparatus comprises:
an object model, storing a plurality of feature parameters corresponding to a plurality of interface objects;
an object detection module, analyzing the image based on the feature parameters to obtain the object information corresponding to at least one of the interface objects in the image; and
a test script interpretation module, interpreting the object information based on a test script to obtain the corresponding test procedure and transmitting the test procedure to the behavior actuation apparatus.

3. The test system as claimed in claim 2, wherein the server apparatus further comprises:
an abnormality notification module, coupled to the test script interpretation module, sending an abnormality notification signal.

4. The test system as claimed in claim 2, wherein the application generates a plurality of testing images, and the server apparatus obtains the test images taken by the image capturing apparatus to obtain a plurality of training images,
analyzing each of the training images based on the feature parameters through the object detection module to obtain the interface objects in the training images,
wherein the server apparatus further comprises:
an object attribute editing module, modifying object attributes of the interface objects; and
a script writing module, generating the test script based on the object attributes of the interface objects.

5. The test system as claimed in claim 4, wherein the object attributes comprise an object category, position information, an execution sequence, an execution behavior, and wait time.

6. The test system as claimed in claim 1, wherein the behavior actuation apparatus comprises:
a first signal transmission interface, coupled to the server apparatus to receive the test procedure;
a second signal transmission interface, coupled to the device under test; and
a microcontroller, coupled to the first signal transmission interface and the second signal transmission interface, executing an input device simulator, and the input device simulator generating the control signal simulating an input behavior of the device under test based on the test procedure received from the first signal transmission interface and transmitting the control signal to the device under test.

7. The test system as claimed in claim 5, wherein the input device simulator comprises at least one of a keyboard simulator, a mouse simulator, a touch screen simulator, a robot arm simulator, a speaker simulator, and a relay simulator.
